(19) United States
(12) Patent Application Publication
(10) Pub. No.: US 2016/0170066 A1
(43) Pub. Date: Jun. 16, 2016

(54) Probability Distribution Based Logging Tool Data Compression

(71) Applicant: Schlumberger Technology Corporation, Sugar Land, TX (US)

(72) Inventor: Nicholas Heaton, Houston, TX (US)

(21) Appl. No.: 14/957,497

(22) Filed: Dec. 2, 2015

Related U.S. Application Data
(60) Provisional application No. 62/090,418, filed on Dec. 11, 2014.

(51) Int. Cl. G01V 3/14; G01V 3/38

(52) U.S. Cl. CPC G01V 3/14; G01V 3/38

(57) ABSTRACT

A method for analyzing a geological formation having a borehole therein may include obtaining at least one measured response for the geological formation from within the borehole using a logging tool, and determining a probability distribution corresponding to the at least one measured response at the logging tool within the borehole. The method may further include determining a plurality of coefficients representing the probability distribution at the logging tool within the borehole, and communicating the coefficients representing the probability distribution from the logging tool within the borehole to a receiving device at the surface of the borehole and without transmitting the at least one measured response to the receiving device from within the borehole.

### CROSS REFERENCE TO RELATED APPLICATIONS

The present disclosure claims priority to U.S. Provisional Application Ser. No. 62/090,418 filed Dec. 11, 2014, the entirety of which is incorporated by reference.

### FIELD OF THE INVENTION

Aspects relate to downhole drilling and evaluation systems. More specifically, aspects relate to probability distribution based logging tools data compression.

### BACKGROUND

Logging tools may be used in wellbores to make, for example, formation evaluation measurements to infer properties of the formations surrounding the borehole and the fluids in the formations. Common logging tools include electromagnetic tools, acoustic tools, nuclear tools, and nuclear magnetic resonance (NMR) tools, though various other tool types are also used.

Early logging tools were run into a wellbore on a wireline cable, after the wellbore had been drilled. Modern versions of such wireline tools are still used extensively. However, the desire for real-time or near real-time information while drilling the borehole gave rise to measurement-while-drilling (MWD) tools and logging-while-drilling (LWD) tools. By collecting and processing such information during the drilling process, the driller may modify or enhance well operations to optimize drilling performance and/or well trajectory.

MWD tools may provide drilling parameter information such as weight-on-bit, torque, shock & vibration, temperature, pressure, rotations-per-minute (rpm), mud flow rate, direction, and inclination. LWD tools may provide formation evaluation measurements such as natural or spectral gamma-ray, resistivity, dielectric, sonic velocity, density, photoelectric factor, neutron porosity, sigma thermal neutron capture cross-section, a variety of neutron induced gamma-ray spectra, and NMR distributions. MWD and LWD tools often have components common to wireline tools (e.g., transmitting and receiving antennas or sensors in general), but MWD and LWD tools may be constructed to endure and operate in the harsh environment of drilling. The terms MWD and LWD are often used interchangeably, and the use of either term in this disclosure will be understood to include both the collection of formation and wellbore information, as well as data on movement and placement of the drilling assembly.

Logging tools may be used to determine formation volumetrics, that is, quantify the volumetric fraction, which may be expressed as a percentage, of each constituent present in a given sample of formation under study. Formation volumetrics involves the identification of the constituents present, and the assigning of unique signatures for constituents on different log measurements. When, using a corresponding earth model, the forward model responses of the individual constituents are calibrated, the log measurements may be converted to volumetric fractions of constituents.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method for analyzing a geological formation having a borehole therein may include obtaining at least one measured response for the geological formation from within the borehole using a logging tool, and determining a probability distribution corresponding to the at least one measured response at the logging tool within the borehole. The method may further include determining a plurality of coefficients representing the probability distribution at the logging tool within the borehole, and communicating the coefficients representing the probability distribution from the logging tool within the borehole to a receiving device at the surface of the borehole and without transmitting the at least one measured response to the receiving device from within the borehole.

A related logging tool is for use with a geological formation having a borehole therein and may include a logging device to obtain at least one measured response for the geological formation from within the borehole. Further, a processor may cooperate with the logging device to determine a probability distribution corresponding to the at least one measured response within the borehole, determine a plurality of coefficients representing the probability distribution within the borehole, and communicate the coefficients representing the probability distribution from within the borehole to a receiving device at the surface of the borehole and without transmitting the at least one measured response to the receiving device from within the borehole.

A related system for analyzing at least one characteristic of a geological formation having a borehole therein may include a communications device outside the borehole for communicating with a logging tool within the borehole, and a processor to receive a plurality of coefficients from the logging tool representing a probability distribution corresponding to at least one response measured by the logging tool within the borehole, and without receiving the at least one measured response from the logging tool from within the borehole. The processor may also determine at least one characteristic of the geological formation based upon the received plurality of coefficients.

A related non-transitory computer-readable medium may have computer-executable instructions for causing a logging tool within a borehole in a geological formation to at least obtain at least one measured response for the geological formation from within the borehole, and determine a probability distribution corresponding to the at least one measured response within the borehole, and determine a plurality of coefficients representing the probability distribution within the borehole. Computer-executable instructions may also be included for causing the logging tool to communicate the coefficients representing the probability distribution from the logging tool within the borehole to a receiving device at the surface of the borehole and without transmitting the at least one measured response to the receiving device from within the borehole.

### BRIEF DESCRIPTION OF THE DRAWINGS

FIG. 1 is a schematic diagram, partially in block form, of a well logging apparatus which may be used for determining characteristics of formation properties in accordance with an example embodiment.

FIG. 2 is a schematic block diagram of an example embodiment of the logging tool of the well logging apparatus of FIG. 1.

FIG. 3 is a flow diagram illustrating method aspects for communicating logging data uphole for use in determining characteristics of formation properties in accordance with an example embodiment.

FIG. 4 is a table of an acquisition sequence used in an example embodiment of the method of FIG. 3.

FIG. 5 is a graph of simulated echo data generated in accordance with the acquisition sequence of FIG. 4.

FIG. 6 is a series of graphs of porosity and T2LM derived from an example database compression scheme and a conventional SVD compression scheme relative to input values.

FIGS. 7-16 are a series of graphs comparing T2 distributions derived from the example database compression scheme and the SVD compression scheme for random samples, in which the lower plots show corresponding window sum reconstructions and the original modeled data with added noise.

FIG. 17 is a schematic diagram, partially in block form, of another well logging apparatus which may be used for determining characteristics of formation properties in accordance with an example embodiment.

FIG. 18 is a flow diagram illustrating method aspects for communicating logging data uphole for use in determining characteristics of formation properties in accordance with another example embodiment.

FIGS. 19 and 20 are graphs of porosity vs. depth for an example maximum entropy compression scheme and a conventional SVD compression scheme.

FIGS. 21-32 are a series of graphs of amplitude vs. time for compressed and model T2 distributions in accordance with an example embodiment.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or operations in different embodiments.

By way of background, to provide feedback from LWD (or wireline) services in real time, such as for Nuclear Magnetic Resonance (NMR) measurement data, when such data is acquired downhole it is compressed before transmission to the surface via telemetry for analysis and delivery. That is, due to the relatively constrained bandwidth of mud-pulse telemetry and the large volume of raw measurement data that may be acquired (particularly for NMR measurements), the compression ratios utilized generally need to be as high as possible. The present disclosure provides various approaches for communicating measurement results, such as NMR measurements, to the surface without the necessity of compressing and transmitting the relatively large amount of raw data acquired by such logging devices over the relatively bandwidth-constrained telemetry communications system. In accordance with a first example embodiment, another approach to such compression techniques is based upon a discretization scheme suitable for NMR or other logging data which represent amplitude distributions. This approach may provide reconstruction accuracy comparable to other compression approaches, yet while requiring a substantially smaller bit budget.

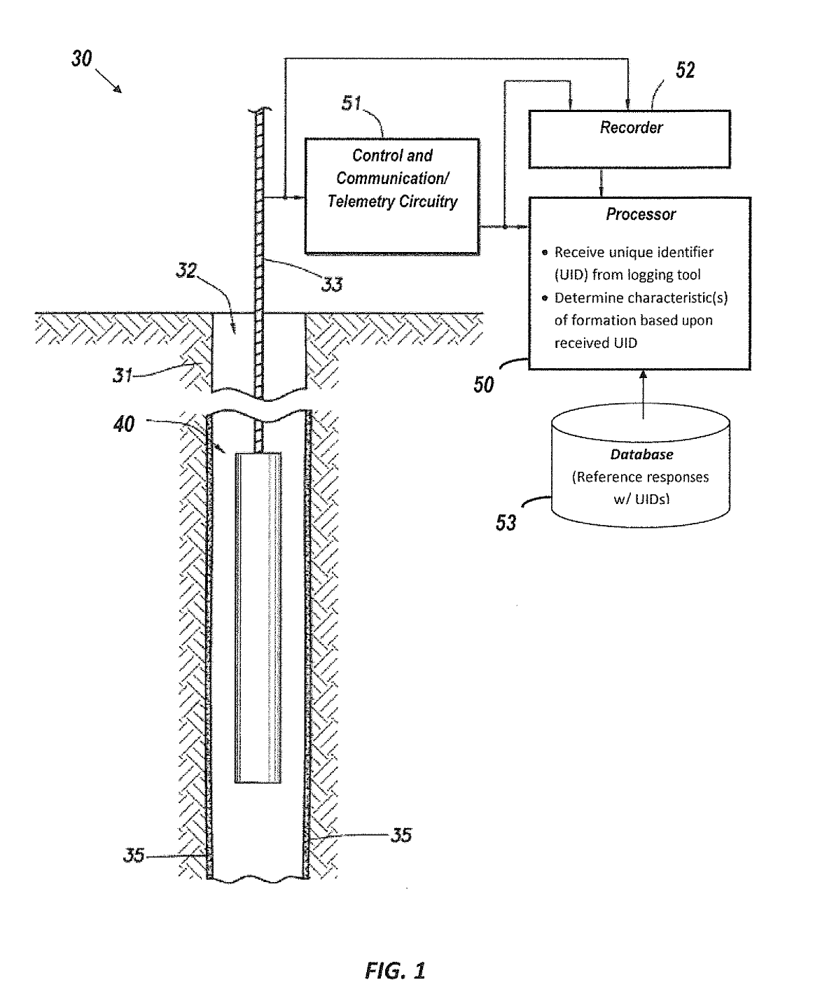

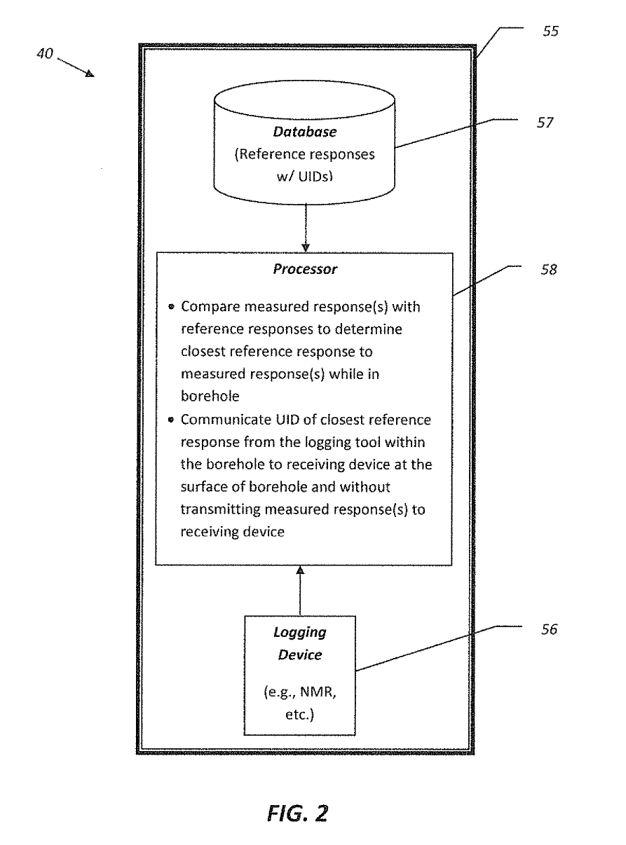

Referring initially to FIGS. 1-3, an example well logging system 30 and associated method aspects are first described. With respect to the flow diagram 60, beginning at Block 61, the system 30 may be used for taking measurements (e.g., multi-dimensional nuclear magnetic resonance (NMR) data measurements) for use in determining characteristics of formation properties, such as porosity, etc., as will be discussed further below. More particularly, a borehole 32 is drilled in a formation 31 with drilling equipment, which may involve drilling fluid or mud. One or more portions of the borehole 32 may be lined with a casing 35, which may include metal (e.g., steel) cylindrical tubing, coiled tubing, cement, or a combination thereof. Other configurations may include: non-metallic casings such as fiberglass, high strength plastic, nano-material reinforced plastics, etc.; screens as used in some completions to prevent or reduce sanding; and slotted liners that may be used in completion of horizontal wells, for example.

A logging tool 40 is suspended in the borehole 32 on an armored multiconductor cable 33 to provide a wireline configuration, although other configurations such as logging while drilling (LWD), measurement while drilling (MWD), Slickline, coiled tubing or configurations such as logging while tripping may also be used. The length of the cable 33 substantially determines the depth of the device 40 within the borehole 32. A depth gauge apparatus may be provided to measure cable displacement over a sheave wheel (not shown), and thus the depth of logging device 40 in the borehole 32.

Control and communication (e.g., telemetry) circuitry 51 is shown at the surface of the formation 31, although portions thereof may be downhole. Also, a recorder 52 is illustratively included for recording well-logging data, as well as a processor 50 for processing the data. However, one or both of the recorder 52 and processor 50 may be remotely located from the well site. The processor 50 may be implemented using one or more computing devices with appropriate hardware (e.g., microprocessor, memory, etc.) and non-transitory computer-readable medium components having computer-readable instructions for performing the various operations described herein.

The tool 40 may include one or more types of logging devices 56 that take measurements from which formation characteristics may be determined. For example, the logging device 56 may be an electrical type of logging device (including devices such as resistivity, induction, and electromagnetic propagation devices), a nuclear magnetic logging device (e.g., NMR), a sonic logging device, or a fluid sampling logging device, as well as combinations of these and other devices, as will be discussed further below. Devices may be combined in a tool string and/or used during separate logging runs. Also, measurements may be taken during drilling, tripping, and/or sliding. Some examples of the types of formation characteristics that may be determined using these types of devices include the following: determination, from deep three-dimensional electromagnetic measurements, of distance and direction to faults or deposits such as salt domes or hydrocarbons; determination, from acoustic shear and/or compressional wave speeds and/or wave attenuations, of formation porosity, permeability, and/or lithology; determination of formation anisotropy from electromagnetic and/or acoustic measurements; determination, from attenuation and frequency of a rod or plate vibrating in a fluid, of formation fluid viscosity and/or density; determination, from resistivity and/or NMR measurements, of formation water saturation and/or permeability; determination, from count rates of gamma rays and/or neutrons at spaced detectors, of formation porosity and/or density; and determination, from electromagnetic, acoustic and/or nuclear measurements, of formation bed thickness.

With respect to NMR tools in particular, NMR measurement presents some extreme challenges in the drilling environment, both from a physics perspective and also because of the demanding data processing required. Modern NMR tools acquire a large amount of raw data, in particular including a series of sub-measurements, each of which includes tens to thousands of individual echoes (Block 62). The large number of echoes (e.g., several thousand) may preclude transmission of the raw data to the surface via telemetry. However, there is high intrinsic redundancy in NMR datasets, and it is possible to achieve substantial reductions in data volume without noticeably compromising accuracy or precision of the final answer products. In fact, some kind of data compression is routinely performed as an initial processing operation in most NMR inversion schemes to improve processing efficiency. Such approaches involve taking a limited number of weighted sums of raw echo amplitudes and submitting these to inversion or transmission uphole via telemetry for subsequent inversion and answer product generation.

By way of example, typical compression methods common for inversion may include window sums and singular value decomposition (SVD) methods. Other compression schemes involving alternate projection functions have been proposed, with the purpose of enabling real-time answer products for LWD NMR services.

In accordance with the present embodiment, a different approach is used which does not involve the reduction through weighted sums. The present approach is not based on projections (i.e., weighted sums) or raw data (e.g., echo amplitudes), but rather defines an index which uniquely identifies the shape of the underlying data to within some specified precision. This approach involves the generation of a database 57 or catalogue of responses which is intended to be sufficiently comprehensive to account for the possible real measurements.

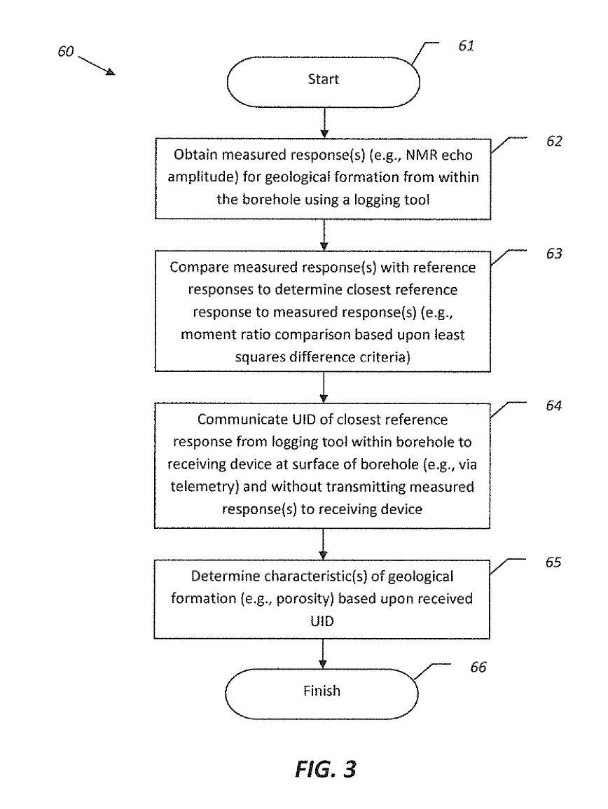

A processor 58 carried by the logging tool 40 may then perform a look-up or comparison procedure to identify which member of the database 57 most closely resembles the actual downhole measurement, at Block 63, and the corresponding index or unique identifier (UID) for this member replaces the compressed raw data, and may instead be transmitted to the surface via telemetry in lieu of the compressed raw data, at Block 64. The processor 50, which also has access to a database 53 with the same data set as the database 57, may then use the UIDs received from the logging tool 40 to look up the corresponding responses from the database, and then determine porosity or other characteristic values based thereon (Block 65), as will be appreciated by those skilled in the art. The method of FIG. 3 illustratively concludes at Block 66. As similarly described above, the processor 58 may also be implemented using appropriate hardware and a non-transitory computer-readable medium having computer-executable instructions for implementing the various operations set forth herein.

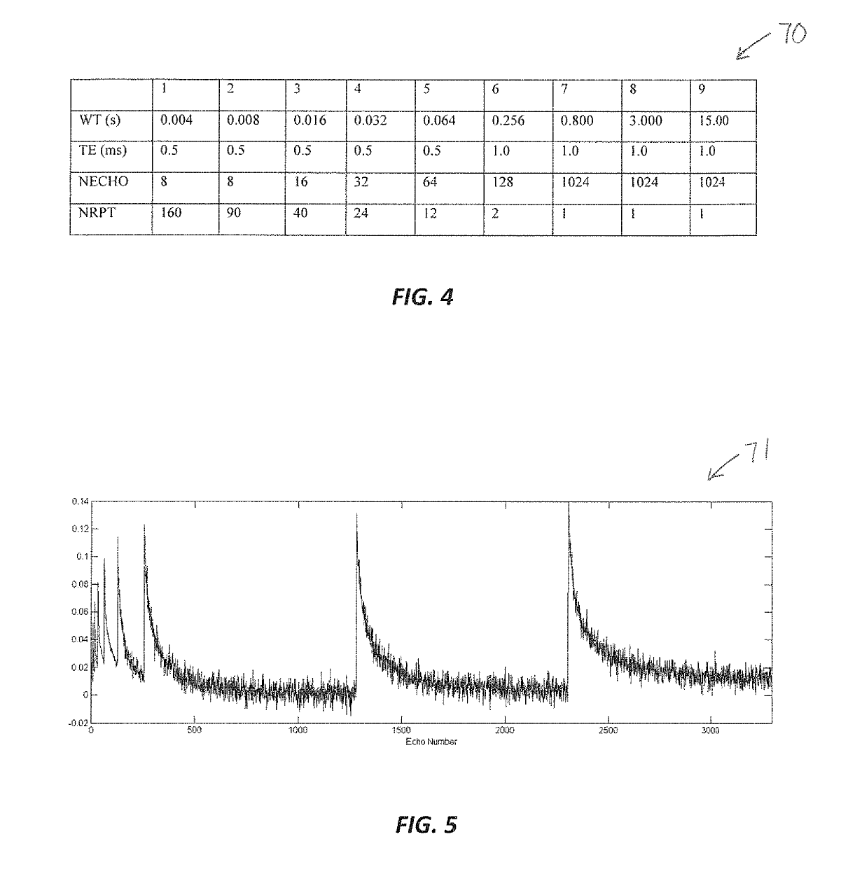

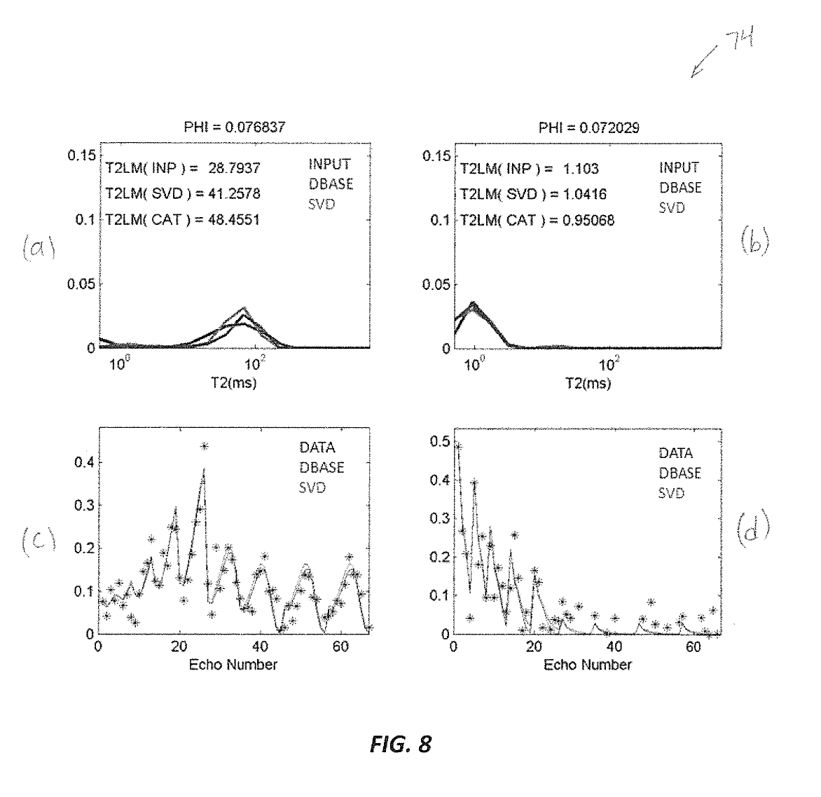

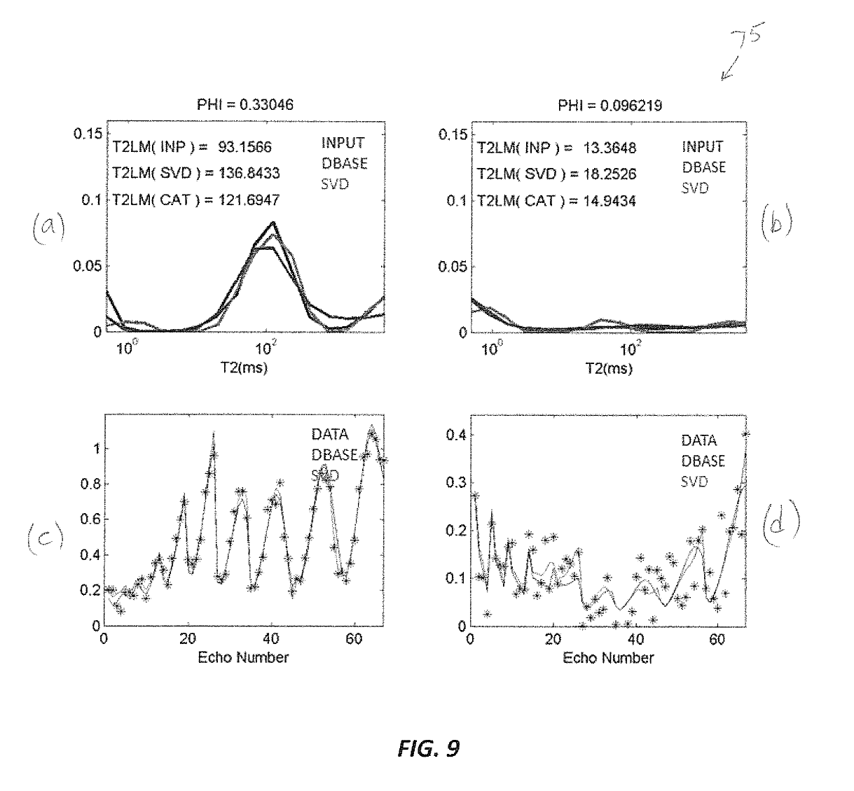

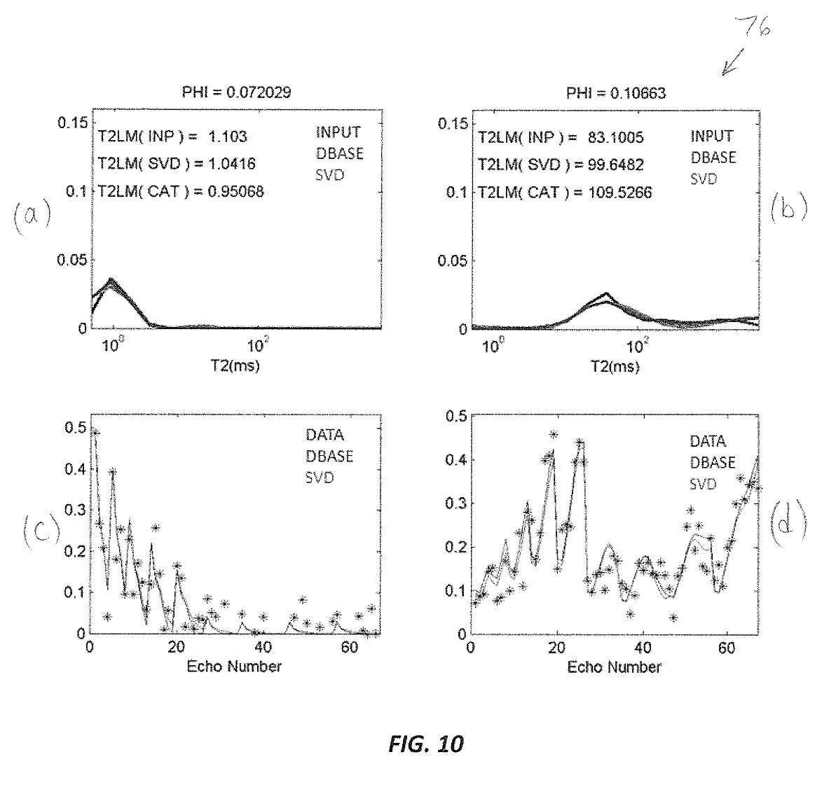

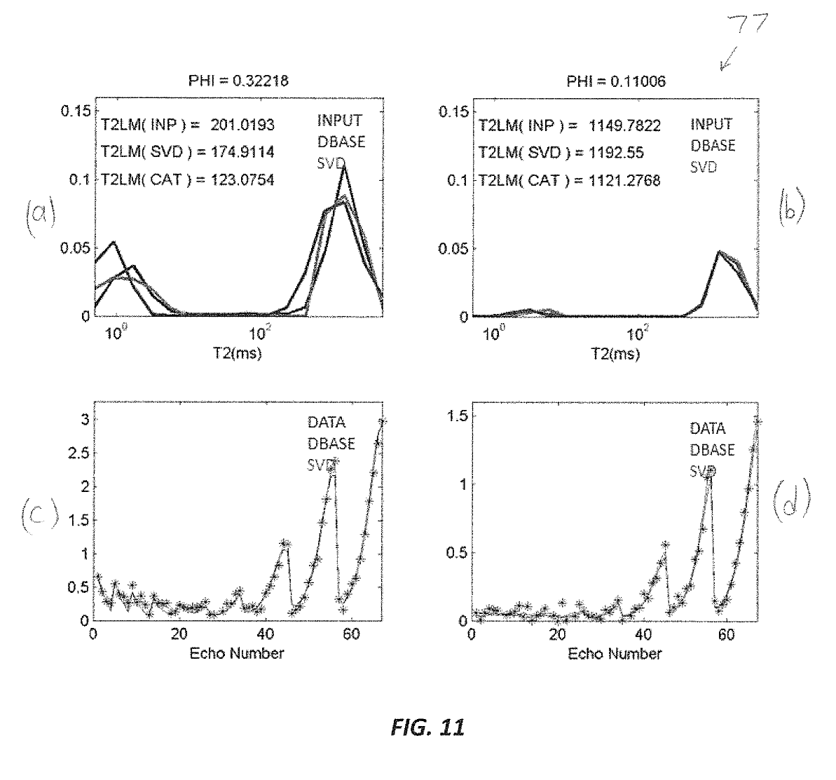

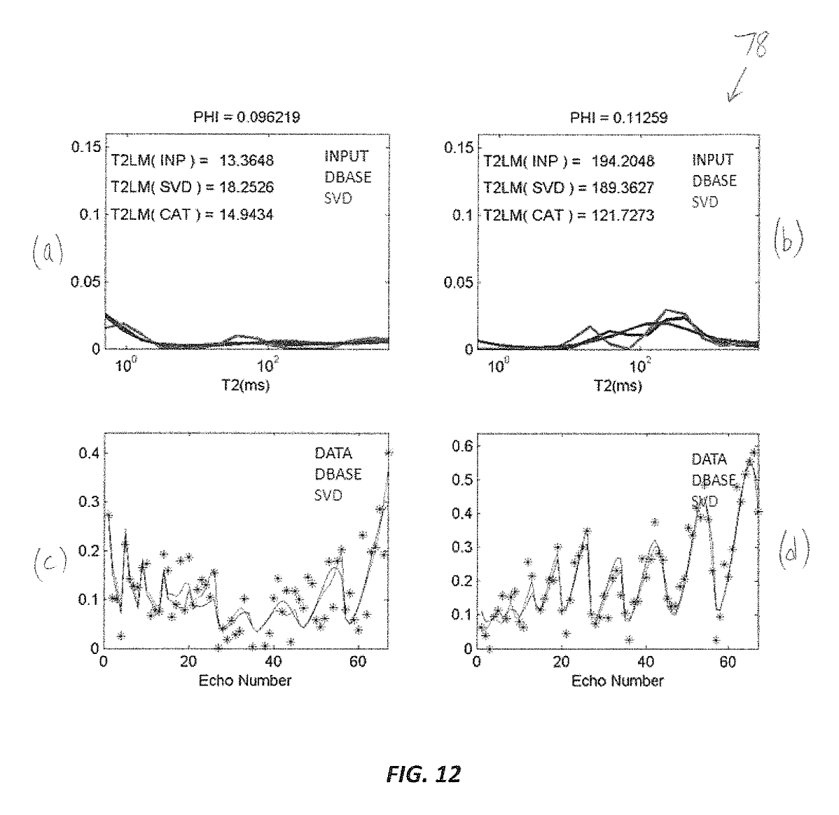

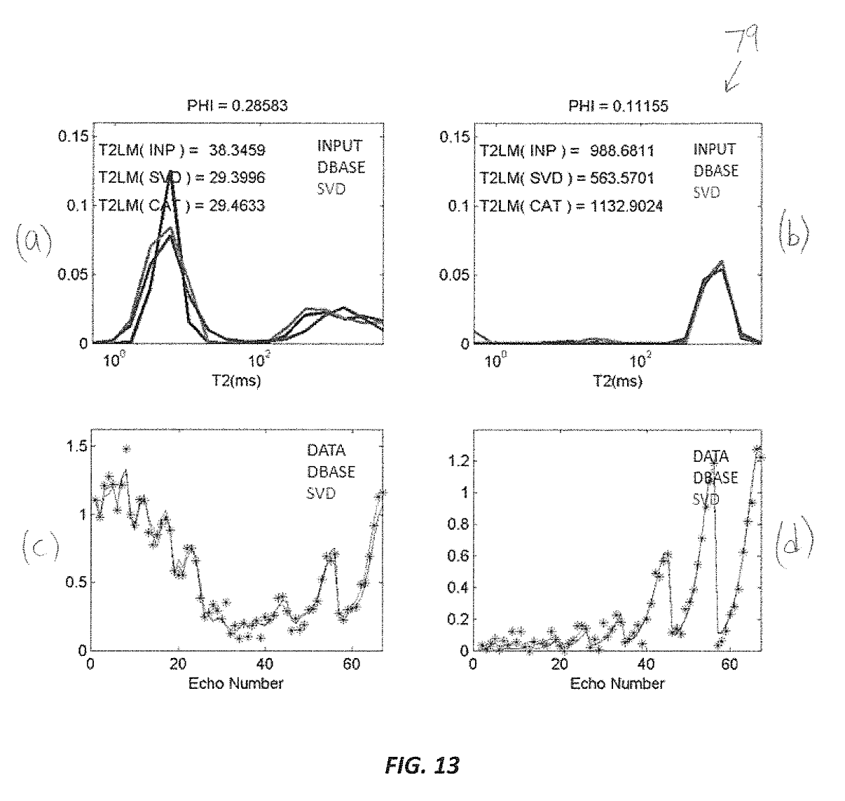

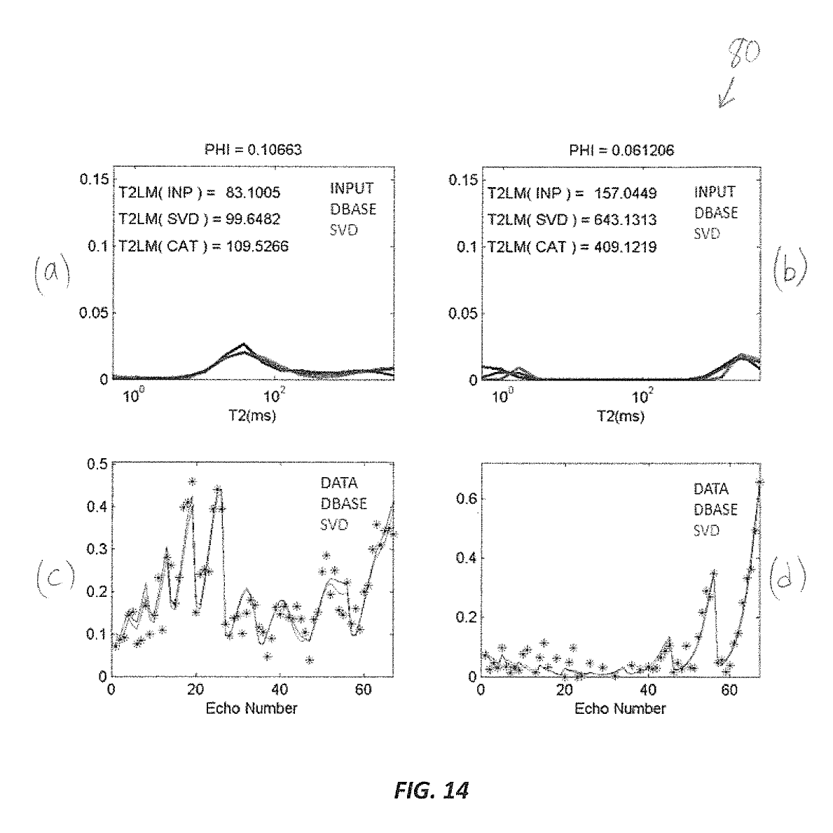

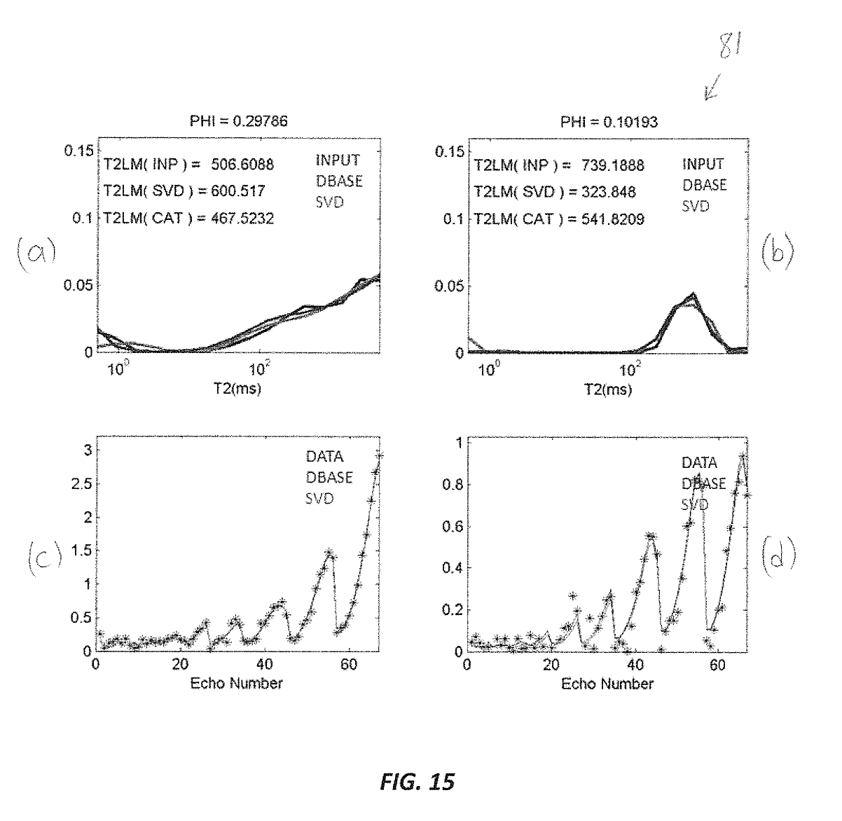

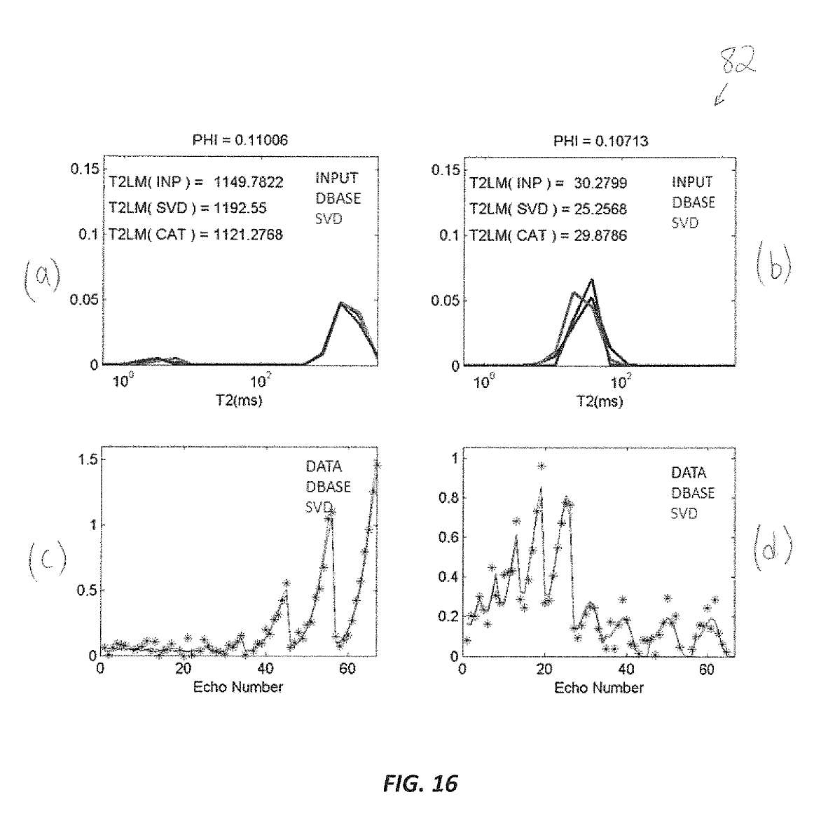

The foregoing will be further understood with reference to an example thereof now described with reference to FIGS. 4-16. More particularly, the present example uses a T1-T2 measurement sequence which may be suitable for next generation LWD NMR tools, and this sequence is summarized in the table 70 of FIG. 4. That is, table 70 provides an acquisition sequence that is used to evaluate the above-described NMR database lookup approach versus a conventional compression method. The raw data generated by the acquisition sequence of table 70 includes nine “echo trains” of different lengths (NECHO) with different degrees of polarization (due to the different wait times—WT), and different noise levels (due to different number of repeats—NRPT). A typical set of simulated of echo trains generated based upon the acquisition sequence set forth in the table 70 is displayed in the plot 71 of FIG. 5.

Efficient compression is facilitated by adopting a realistic physical model for the NMR responses. For NMR relaxation measurement schemes such as the one summarized in table 70, a suitable response kernel is:

K(i, j, T₁, T₂)=\sqrt{N_{R}}[1−exp(−WTⱼ/T₁)]exp(−nᵢTEⱼ/T₂) (1)

where T₁ and T₂ are longitudinal and transverse relaxation times, WTⱼ and TEⱼ are the wait-time and echo spacing for the j^{th} sub-measurement, and N_{R} is the number of times the sub-measurement is repeated. Inclusion of the \sqrt{N_{R}} term helps ensure a uniform precision for the echoes in the full measurement sequence. Different and/or more complex acquisition schemes may be used with different response kernels, as will be appreciated by those skilled in the art. However, once the appropriate kernel is established, the following data analysis and compression scheme can be applied. It is convenient to express the NMR echo amplitudes, A, as a vector. Standard matrix formalism may then be used to relate the echo amplitudes to the target distribution f. In the present case, this is a function of T₁ and T₂, which may also be unraveled as a vector. To reduce dimensionality it may be helpful to express the kernel in terms of its singular vectors, U and V, and the corresponding singular values, S, where

A=Kf(T₁, T₂)=USV′f(T₁, T₂) (2)

Rearranging equation (2), we define a set of distribution “moments”, Sₙ<Vₙ>, which may be conveniently evaluated as projections of the singular vectors on the measured echo amplitudes, and gives the following:

$$〈 {V}_{n}^{*} 〉 = {S}_{n} 〈 {V}_{n} 〉 = {SV}^{′} f ( {T}_{1} , {T}_{2} ) = {S}_{n} {\sum }_{j} {V}_{n} ( j ) f ( j ) = {U}^{′} A = {\sum }_{i = 1}^{NECHO} {U}_{n} ( i ) A ( i ) = 〈 {U}_{n} 〉 \qquad ( 3 )$$

In practice, the measured echo amplitudes contain noise, which ultimately limits the precision of the computed moments. The orthonormal property of the U vectors helps to ensure that the precision of the computed moments is equal to the standard deviation of the echo amplitudes.

Although the total number of moments is defined by the size of the target distribution, the moments decay rapidly and the number of relevant moments is far less, determined by the measurement noise. For a real T₁-T₂ log measurement with typical downhole noise levels, the number of measurable moments is generally on the order of ten to twelve. In fact, for the purposes of evaluating the relaxation time distribution and deriving associated petrophysical answers, it may be sufficient to consider fewer moments.

In the preceding discussion it was implicitly assumed that the distribution f is normalized to 1. However, for well logging applications, the distribution is in effect scaled by the porosity.

$$〈 {U}_{m} 〉 = φ {S}_{m} {\sum }_{j} {V}_{m} ( j ) f ( j ) \qquad ( 4 )$$

Therefore, the measured moments contain information about the porosity as well as the shape of the underlying relaxation time distribution. For the purposes of compression applications, it is helpful to normalize the moments such that the maximum and minimum values are well-defined, which facilitates the definition of quantization schemes. One approach is to use the porosity as the normalization constant.

$$〈 {U}_{m}^{( φ )} 〉 = \frac{〈 {U}_{m} 〉}{φ} \qquad ( 5 )$$

An advantage of this approach is that the moments may be normalized and the limits of the normalized moments are merely given by the minimum and maximum values of the SV vectors. A drawback is that the porosity computation involves some kind of inversion. While some linear schemes have been proposed for this, such approaches may introduce some degree of error. Another scheme uses the first moment as the normalization constant:

$$〈 {C}_{m} 〉 = \frac{〈 {U}_{m} 〉}{〈 {U}_{1} 〉} \qquad ( 6 )$$

This approach does not require any porosity value for the normalization and reduces the number of terms needed to define the distribution shape. The first moment itself is not normalized. Its value includes porosity as well relaxation time (i.e., distribution shape) information so the associated quantization scheme may be designed to cover the appropriate range covering the expected porosity values. In the following discussion, the first moment normalization scheme will be used for the compressed moments.

A relevant operation in the proposed compression concerns the parametric approximation of the distribution function. It is known that exponential functions provide an efficient parameterization of distributions, particularly when limited information (e.g., partial set of moments) concerning the distributions is available.

$$f ( j ) = {Z}^{- 1} exp [ {\sum }_{k} {a}_{k} {V}_{k}^{*} ( j ) ] \\ Z = {\sum }_{j} exp [ {\sum }_{k} {a}_{k} {V}_{k}^{*} ( j ) ] \qquad ( 7 )$$

Given a limited set of known distribution moments, this form of distribution corresponds to that with maximum entropy, where the entropy is given by:

$$\begin{matrix}S = - k {\sum }_{j} f ( j ) log f ( j ) \\ = k [ log ( Z ) - {\sum }_{i} {a}_{i} 〈 {V}_{i}^{*} 〉 ]\end{matrix} \qquad ( 8 )$$

An attractive feature of this formulation is that a relatively small number of terms, aₖ, can describe a broad range of distributions. The above-noted database lookup approach uses this property of the distribution. The method involves the generation of a comprehensive database of distributions f(a), and evaluating the corresponding normalized moments, [symbol] U*ₘ [symbol] or [symbol] Cₘ [symbol] . Because a large number of distributions are required to reasonably cover possible distributions encountered in practice, it is a consideration that the range of moments be sampled as evenly as possible. In other words, it may be desirable to avoid populating the database with samples for which the measured moments are indistinguishably close. To achieve this, it is convenient to make use of the properties of the distribution function in equation (7) above. With this definition, analytic forms for the partial derivatives of moments with respect to the exponential factors, aₖ, are available.

∂ [symbol] U*ₘ [symbol] /∂aⱼ= [symbol] U*ₘU*ⱼ [symbol] − [symbol] U*ₘ [symbol] [symbol] U*ⱼ [symbol] (9)

Armed with the partial derivatives successive samples may be generated by varying a single factor, aₖ, at a time and ensuring that the sum of squared differences in moments between the samples is equal to some specified value. This provides an efficient sampling of the moment space with a reduced size database.

$${( Δ {U}^{2} )}_{j} = {\sum }_{m} {( Δ {U}_{m}^{2} )}_{j} = {\sum }_{m} {( Δ {a}_{j} \partial 〈 {U}_{m} 〉 / 2 {a}_{j} )}^{2} = {Δ}_{j}^{2} = {Δ}^{2} \\ Δ {a}_{j} = Δ / \sqrt{{\sum }_{m} {( \partial 〈 {U}_{m} 〉 / 2 {a}_{j} )}^{2}} \qquad ( 10 )$$

Algorithms may be used to populate the database using the approach described above. The algorithm adopted here uses a progressive sampling scheme commencing with the lowest rank coefficient, while fixing higher rank coefficients equal to zero. Successively higher rank coefficients are sampled using the previous samples as a reference. The total number of samples then increases approximately geometrically with the number of coefficients used. Parameters which may be used to define the database include: maximum rank of coefficients kₘₐₓ; maximum and minimum values for the coefficients aₖ; step size Δ (in practice this can be determined by fixing number of samples); and number of moments (or moment ratios) to define each sample. This method constitutes just one approach for optimizing the database. Other algorithms may also be envisaged which effect an optimization (or minimization) of the database.

The above-noted approach was evaluated using simulated NMR data generated using the acquisition scheme summarized in table 70. A total of 1000 echo datasets were generated from random relaxation time distributions, a T₁, T₂ NMR kernel (equation (1)), scaled with and added Gaussian noise of 5 pu per echo. In order to validate the generality of the method, the distributions were created with a different mathematical expression (more complex, with more parameters) than that used to generate the database (i.e., equation (7)).

A database was generated with the following parameters:

| Database Parameter | Value |
|---|---|
| Maximum rank of coefficients kₘₐₓ | 4 |
| Maximum value of coefficients | +0.75 |
| Minimum value of coefficients | −0.75 |
| Number of samples | ~65536 = 2¹⁶ |
| Maximum rank of computed moments | 12 |

With this scheme, each database entry is defined by an absolute value of the first moment, and eleven moment ratios (equation (6)), which are evaluated with a unique set of four aₖ coefficients. Coefficient selection was performed using the step-size criteria implied by equation (10). In order to reduce the overall size of the database, each moment ratio was quantized to an 8-bit precision, corresponding to an overall volume requirement of less than 1 MB for the full database. Each sample has a unique associated identifier from 1 to 2¹⁶, which identifies or represents the “compressed” data set.

For the purpose of this evaluation, “downhole” compression is achieved simply by comparing the measured moment ratios with those of each member of the database and identifying the database sample which provides the best match, e.g., based up a on least squares difference criteria. The identifier (16 bits) corresponding to the best fit sample is then transmitted to the surface. Having identified the distribution identifier, a porosity value was then estimated by comparing normalized moments, [symbol] Uₘ [symbol] , derived from the database, with the corresponding measured values, Ūₘ.

$$φ = \frac{\sum {\overline{U}}_{m}^{2}}{\sum 〈 {U}_{m} 〉 {\overline{U}}_{m}} \qquad ( 11 )$$

Even without any search optimization, this “brute-force” scheme provides relatively fast compression—comparable in clock time to CGP inversion of the same data. However, a relatively large (potentially orders of magnitude) improvement in computation efficiency may be achieved with a guided search approach based upon ordering of the database samples according to moment ratio values.

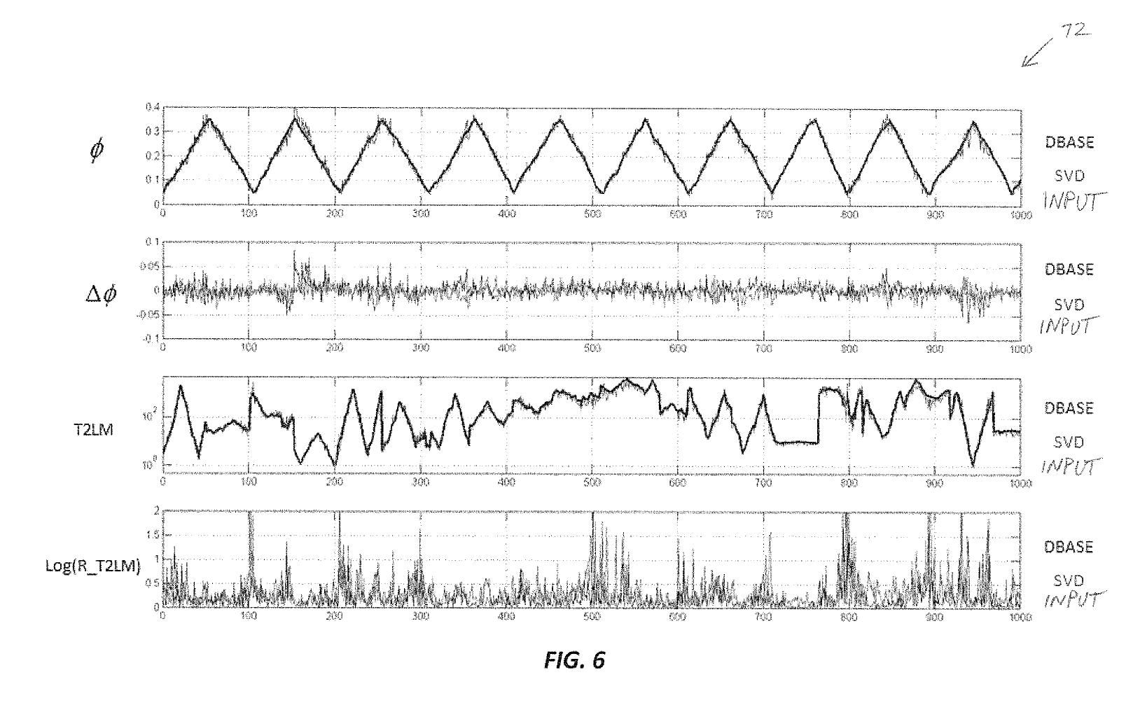

Results from the example implementation are shown in the respective series of graphs 72-82 shown in FIGS. 6-16. Comparisons are made with results derived from a compression scheme in which normalized SVD projections (6 projections, 30 bits) are transmitted. FIG. 6 compares porosity (top panel) and T2LM values (3^{rd} panel). Input model values, database comparison scheme results (following compression-decompression workflow), and SVD projection compression results (i.e., following compression-decompression) are shown as indicated by the associated legend. The SVD porosity was computed using a linear estimator as follows:

$${φ}_{SVD} = {\sum }_{k} {β}_{k} 〈 {V}_{k}^{*} 〉 \\ {β}_{k} = \frac{1}{{S}_{k}} {\sum }_{i} {V}_{k} ( i ) \qquad ( 12 )$$

The second panel of FIG. 6 shows the difference between compression porosity results and input values. The fourth panel plots the logarithm of the ratio of T2LM from compression-decompression dataflows with input value. As for the other panels, the various curves correspond to the database and SVD compression schemes as indicated by the associated legends.

The following table summarizes the output results:

| | Database | SVD |
|---|---|---|
| | Scheme | Scheme |
| Mean Porosity Error (pu) | 0.10 | −0.03 |
| Standard Deviation Porosity Error (pu) | 1.40 | 1.30 |
| Mean T2LM error (%) | 21 | 26 |

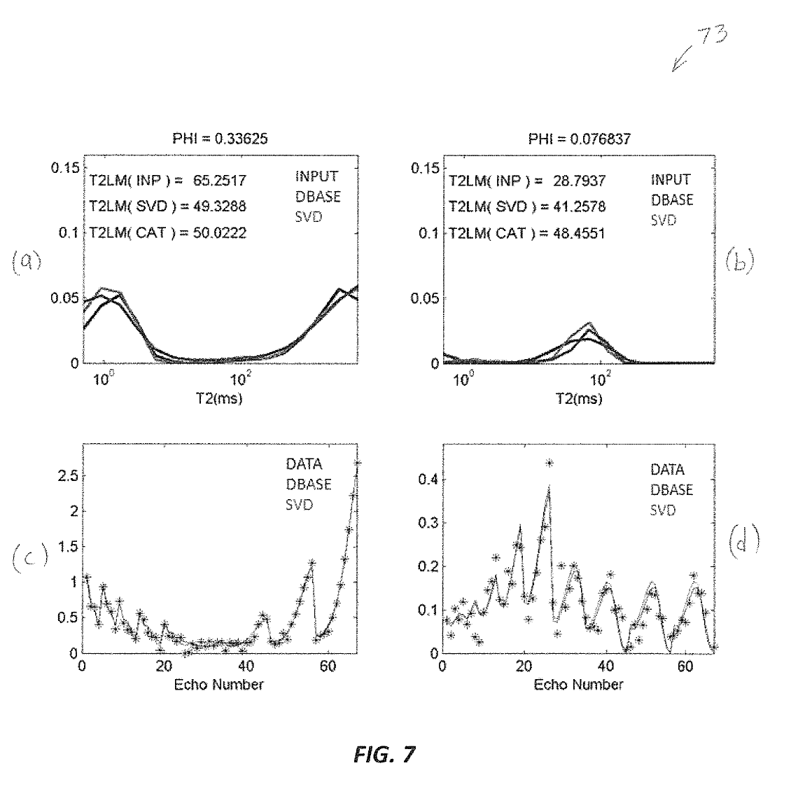

Respective panels (a)-(d) of FIGS. 7-16 show T2 distributions and fits to window sums for twenty randomly selected samples from the 1000 sample test datasets. Input model data is indicated by the associated curve shown in the legend and the point, and the curves corresponding to the database and SVD compression schemes are also indicated in the associated legends.

The results summarized in the table above and in FIGS. 6-16 demonstrate that the 16-bit database compression scheme provides comparable quality results to those obtained using a 30-bit SVD compression, although the SVD-based linear estimator provides slightly better porosity precision than the reconstructed database method. However, the database comparison approach provides slightly improved T2LM estimate relative to SVD-based compression. Moreover, it should be noted that a database comparison of normalized distribution may be combined with a linear SVD porosity estimator (or other suitable estimator) to obtain enhanced overall answers, as will be appreciated by those skilled in the art.

It should also be noted that a similar database approach may be implemented in the echo (or window sum) domain, instead of relaxation time distribution space. This may potentially provide some reduction in database size, for example. Furthermore, in some implementations, improvements in overall precision and accuracy may be achieved by increasing the maximum rank of coefficients (e.g., 5 instead of 4, etc.), as will be appreciated by those skilled in the art. Moreover, the database approach may also lend itself to uncertainty evaluation for derived answers. To extend the method to higher dimensional data (e.g., diffusion editing), appropriate optimization and/or modifications may be performed, such as database size reduction, as will also be appreciated by those skilled in the art.

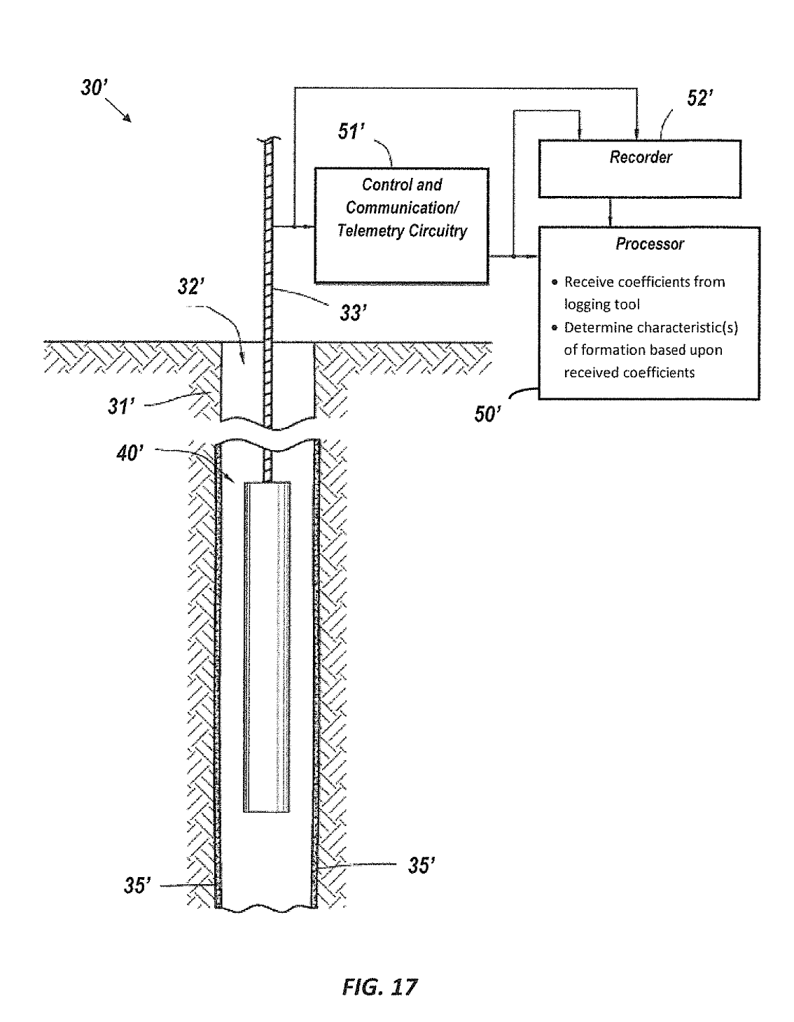

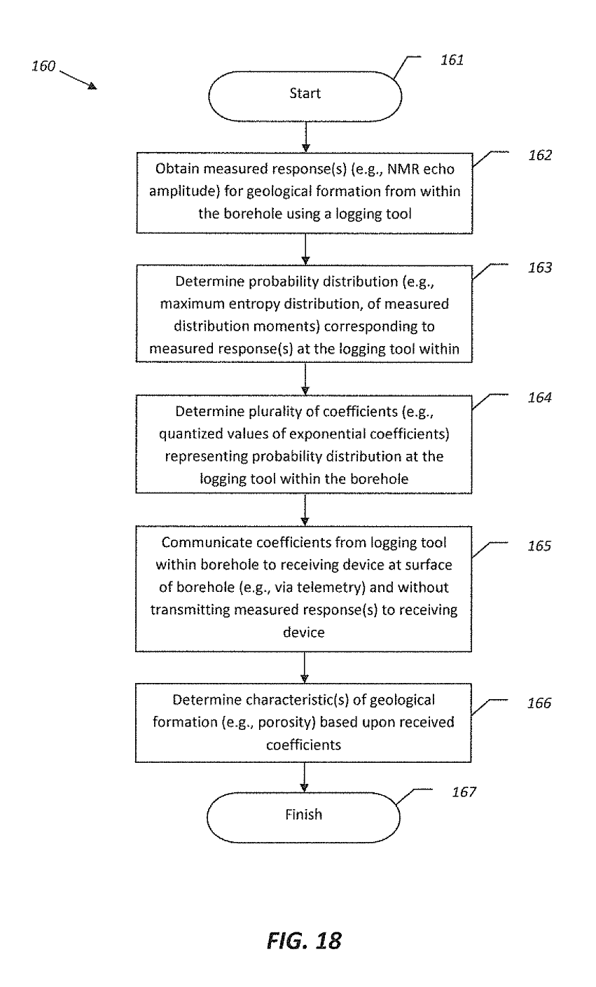

Turning now to FIGS. 17 and 18, another data “compression” approach is now described which is based upon a downhole inversion to derive a probability distribution, such as a maximum entropy distribution, for NMR data or other data which represent amplitude distributions. With respect to the well logging system 30′, those components indicated with prime notation which are similar to those discussed above will not be mentioned again here except to describe the differences in operation in the current embodiment.

Generally speaking, beginning at Block 161 of the flow diagram 160, the probability distribution approach includes obtaining at least one measured response for the geological formation 31′ from within the borehole 32′ using the logging tool 40′, at Block 162, as discussed above. The method further illustratively includes determining a probability distribution corresponding to the at least one measured response at the logging tool 40′ within the borehole 32′ (Block 163), and determining a plurality of coefficients representing the probability distribution at the logging tool within the borehole (Block 164), as will be discussed further below. Furthermore, the coefficients representing the probability distribution may be communicated from the logging tool 40′ within the borehole 32′ to the receiving device 51′ at the surface of the borehole and without transmitting the at least one measured response to the receiving device from within the borehole (Block 165), as similarly described above. Again, formation characteristics (e.g., porosity, etc.) may similarly be determined from the received coefficients, at Block 166, which illustratively concludes the method of FIG. 18 (Block 167).

As noted above, an attractive feature of formulation of equation (8) is that a relatively small number of terms, aₖ, can describe a broad range of distributions. The current approach also relies on this property of the distribution. Combining equations (4), (6) and (7) we obtain:

$${C}_{m} = \frac{{\sum }_{j} {V}_{m}^{*} ( j ) exp [ {\sum }_{k = 1}^{KMAX} {a}_{k} {V}_{k}^{*} ( j ) ]}{{\sum }_{j} {V}_{1}^{*} ( j ) exp [ {\sum }_{k = 1}^{KMAX} {a}_{k} {V}_{k}^{*} ( j ) ]} = \frac{{\sum }_{j} {U}_{m} ( j ) exp [ {\sum }_{k = 1}^{JMAX} {b}_{k} {U}_{k} ( j ) ]}{{\sum }_{j} {U}_{1} ( j ) exp [ {\sum }_{k = 1}^{JMAX} {b}_{k} {U}_{k} ( j ) ]} \qquad ( 13 )$$

The minimum number of coefficients (e.g., KMAX) to be used in the exponential function depends on the acquisition sequence and on the signal-to-noise ratio (SNR) of the data. In practice, for the T1-T2 acquisition scheme of table 70 and for noise levels typical of LWD NMR tools, five coefficients may be sufficient, although other numbers may be used in different embodiments. The coefficients aₖ may be determined by inversion. In practice this may be achieved by minimization of a suitable cost function, such as:

$${ψ}^{2} = {\sum }_{m} {( {C}_{m} - 〈 {C}_{m} 〉 )}^{2} \\ \frac{\partial {ψ}^{2}}{\partial {a}_{k}} = 0 \qquad ( 14 )$$

The above-described approach uses the right-sided SVD vectors (V*ₖ) as basis functions for the target amplitude distribution (i.e., T1-T2 distribution). Another related approach uses the left-hand vectors (Uₖ) to represent the measured data:

$${C}_{m} = \frac{{\sum }_{j} {U}_{m} ( j ) exp [ {\sum }_{k = 1}^{JMAX} {b}_{k} {U}_{k} ( j ) ]}{{\sum }_{j} {U}_{1} ( j ) exp [ {\sum }_{k = 1}^{JMAX} {b}_{k} {U}_{k} ( j ) ]} \qquad ( 15 )$$

In principle, the measured data may be raw echo amplitudes, window sums, or some other linear combinations of echo amplitudes, provided that the data are positive valued and that the corresponding SVD vectors are properly incorporated. The coefficients bₖ, may be computed in the same manner as described previously, but in this case they represent data points or compressed data points rather than the normalized relaxation time amplitude distribution. It should be noted that while the downhole algorithms for the data-based and relaxation-distribution compression schemes are basically identical, with practical differences being the definition of the singular vectors used to define the corresponding “distributions” and their respective SVD projections.

The example method has also been evaluated using the same simulated NMR data generated using the acquisition scheme summarized in table 70 (FIG. 4). Two series of simulations were performed, each including 200 raw datasets with added Gaussian noise of 7 pu per echo per PAP. Three-level averaging is applied for each compressed dataset, reducing the effective noise per echo to ˜4 pu. In the first series, model data was generated from T2 distributions corresponding to two log-Gaussian T2 peaks with random amplitude, mean T2 and width. The second series was generated from T2 distributions corresponding to single narrow T2 peaks with amplitude of 35 pu.

A number of parameters and algorithms may be selected for implementation of the above-noted method. Example parameters and the values used for this demonstration are summarized in the following table:

| Parameter Method | Value Used for Demo |
|---|---|
| Maximum rank of coefficients KMAX | 5 |
| Range of values of coefficients | −2.0 < aₖ < +2.0 |
| Quantization scheme for coefficients aₖ | Non-uniform spacing |
| Number of bits for quantization (including | 42 |
| porosity) | |
| Optimization method used for inversion | Levenberg-Marquardt |

Results for the two series are summarized in the table below. Comparisons are made with results derived from a compression scheme in which normalized SVD projections (here 6 projections, 36 bits) are transmitted.

| | |
|---|---|
| Maximum | |
| Entropy | SVD |
| Scheme | Scheme |

Series 1

| | | |
|---|---|---|
| Mean Porosity Error (pu) | −0.20 | −0.15 |
| Standard Deviation Porosity Error (pu) | 1.05 | 0.77 |
| Mean T2LM error (%) | 27 | 37 |

Series 2

| | | |
|---|---|---|
| Mean Porosity Error (pu) | 0.80 | 1.54 |
| Standard Deviation Porosity Error (pu) | 1.12 | 2.29 |
| Mean T2LM error (%) | 8 | 12 |

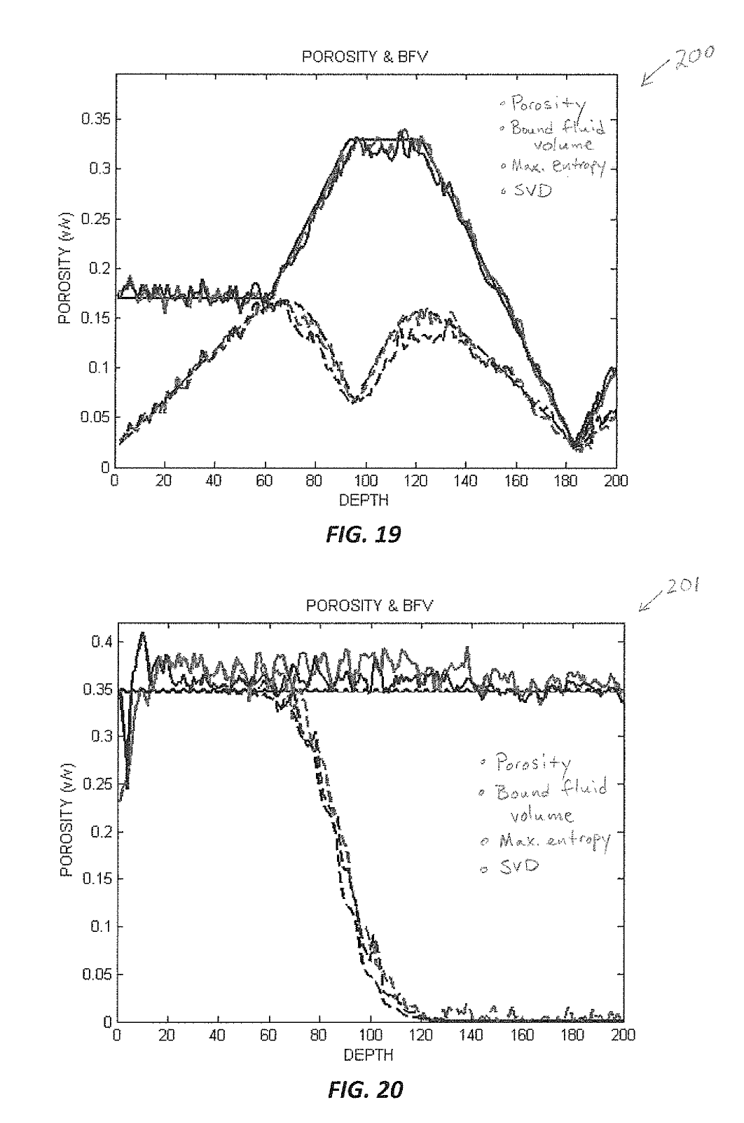

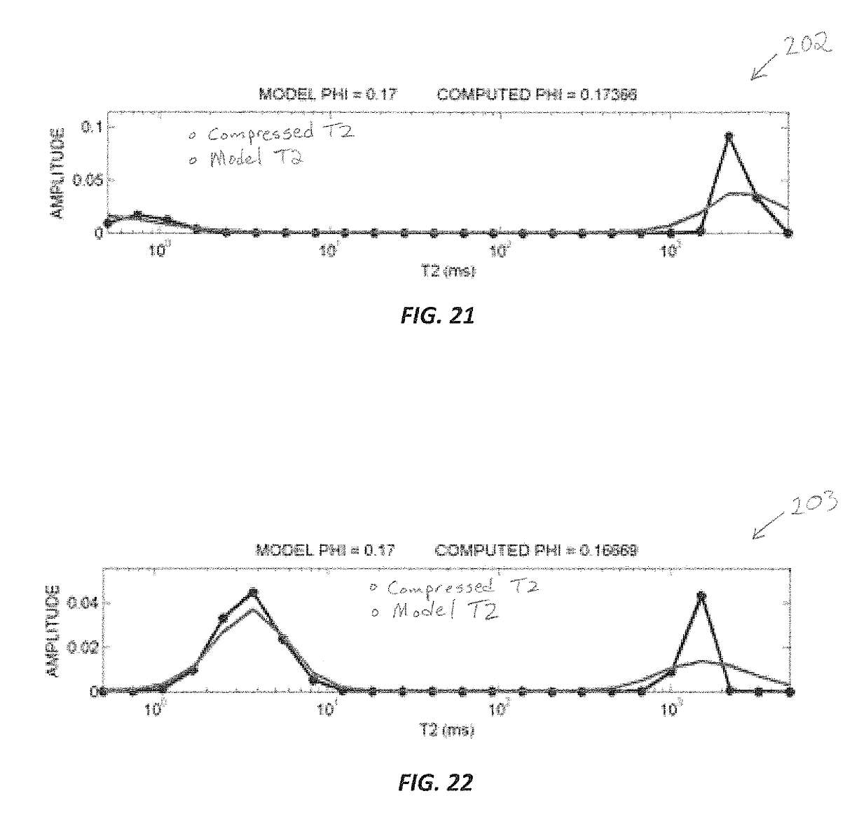

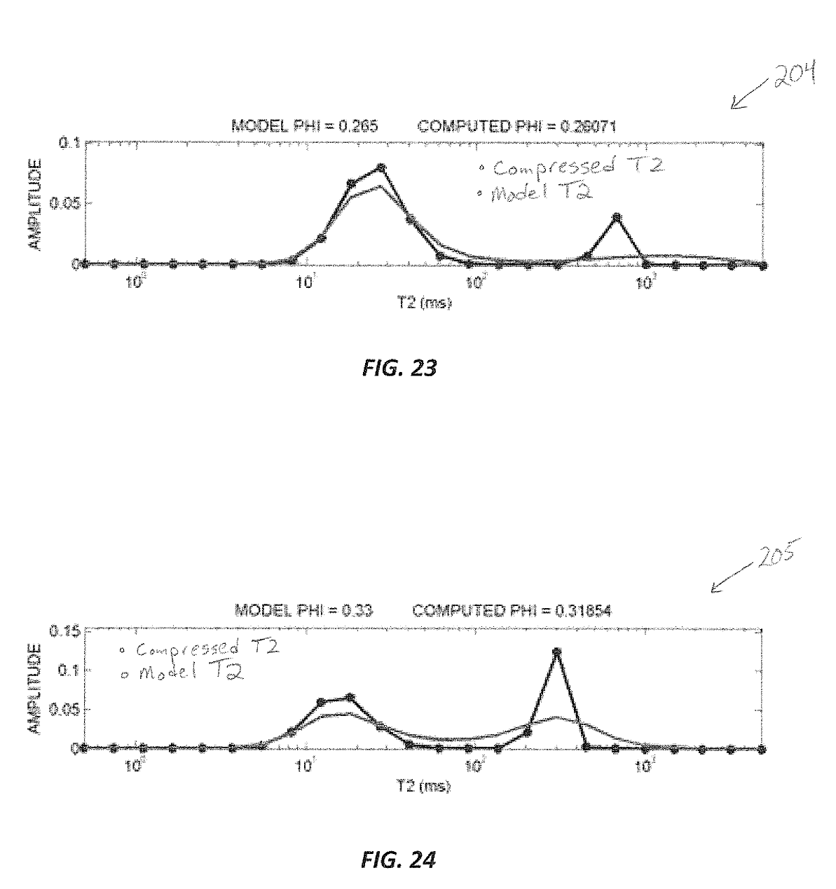

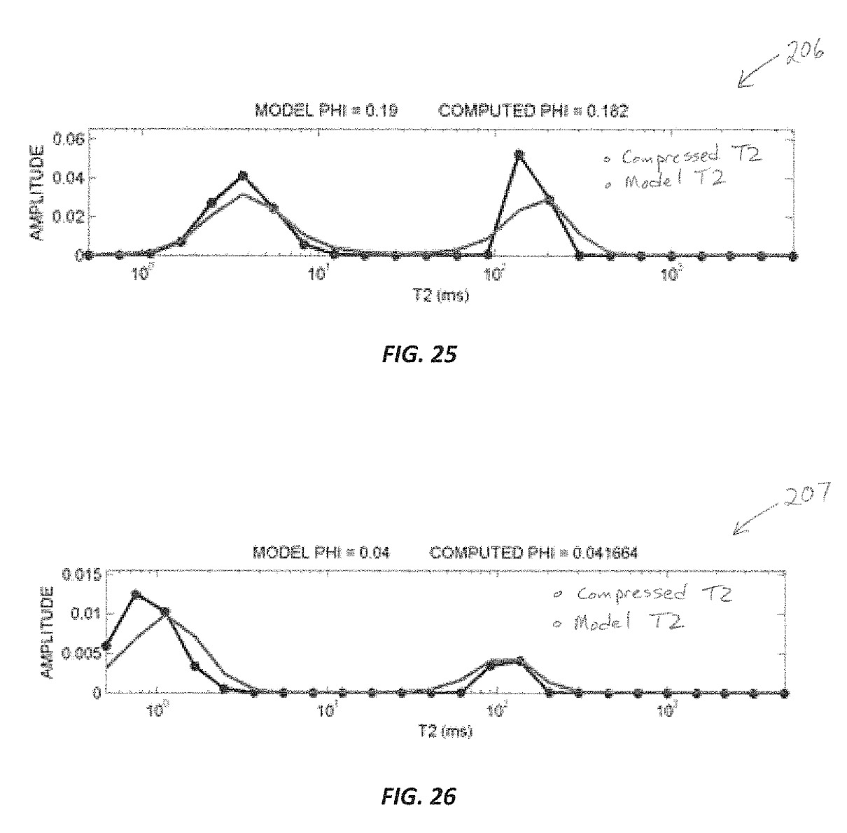

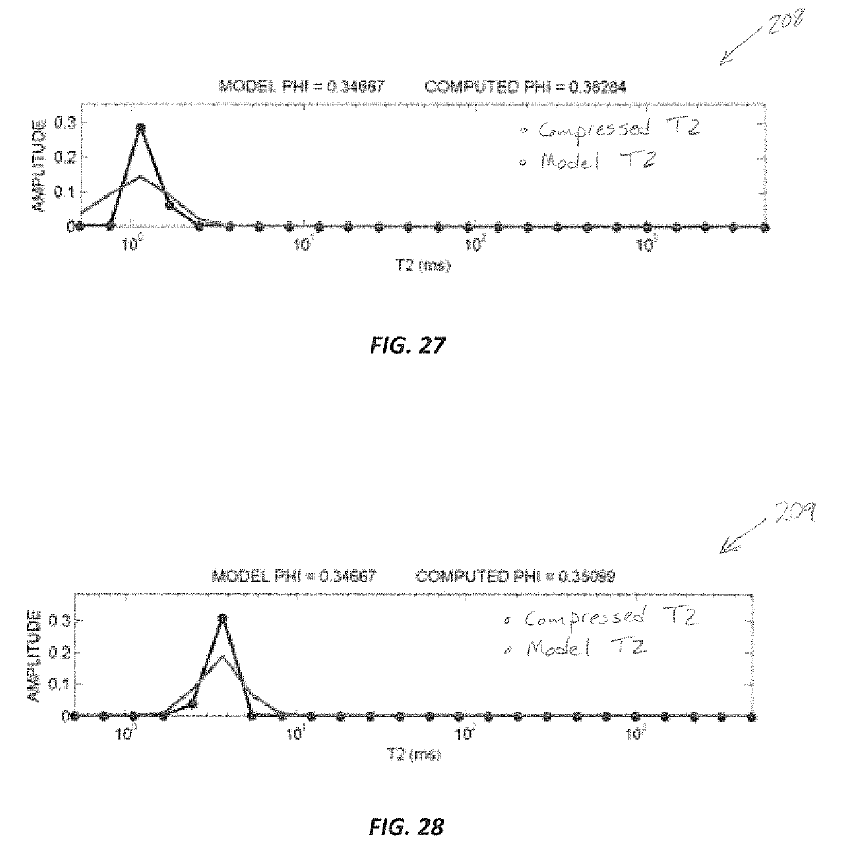

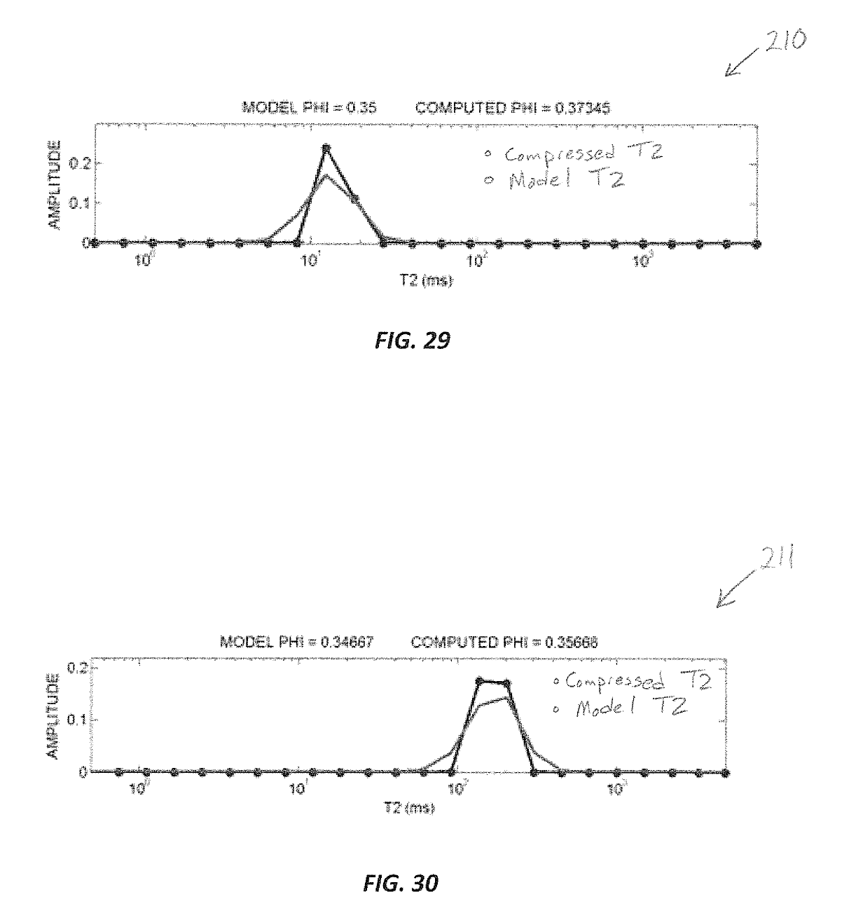

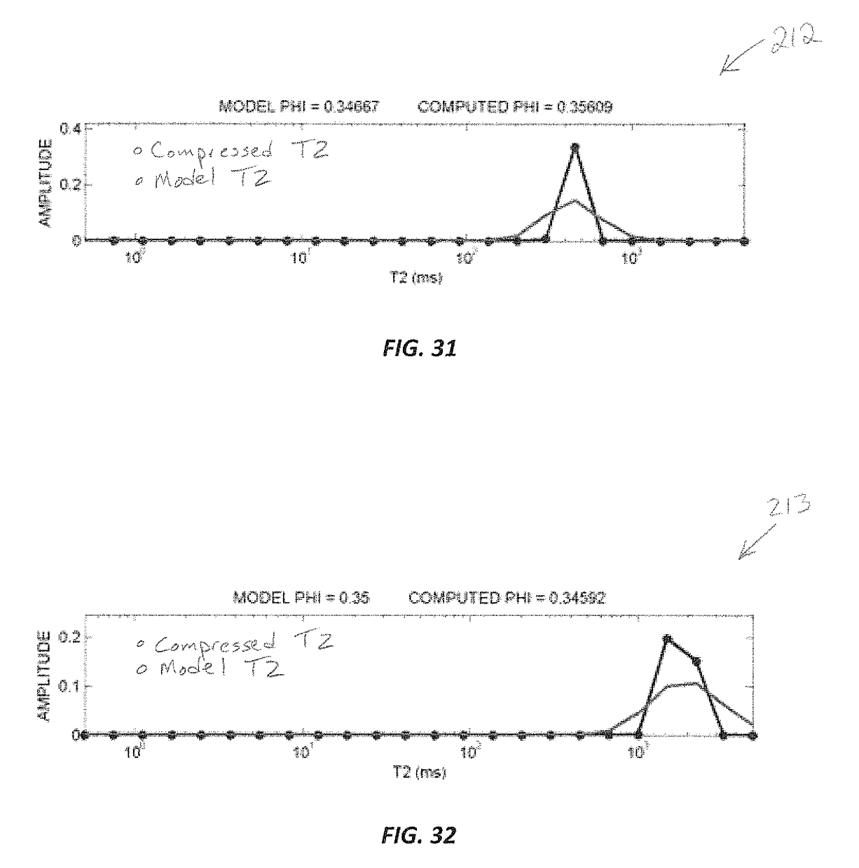

The results summarized in the above table and in the graphs 200-213 of FIGS. 19-32 demonstrate that the 42-bit maximum entropy scheme provides comparable quality results to those obtained using a 36-bit SVD compression, as will be appreciated by those skilled in the art. Furthermore, the SVD-based linear estimator provides slightly better porosity precision than the maximum entropy approach for two Gaussian peaks, but the SVD projection scheme produces a noticeable porosity error for single peak distributions, which is not observed for the maximum entropy scheme. Moreover, the maximum entropy scheme provides slightly improved accuracy and precision for T2LM for the datasets, although both schemes provide reduced T2LM error for single peak distributions. In addition, a small bias in BFV is observed for the maximum entropy scheme in situations where two peaks are separated by about a decade centered close to the T2 cutoff.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A method for analyzing a geological formation having a borehole therein and comprising:
obtaining at least one measured response for the geological formation from within the borehole using a logging tool;
determining a probability distribution corresponding to the at least one measured response at the logging tool within the borehole;
determining a plurality of coefficients representing the probability distribution at the logging tool within the borehole; and
communicating the coefficients representing the probability distribution from the logging tool within the borehole to a receiving device at the surface of the borehole and without transmitting the at least one measured response to the receiving device from within the borehole.

2. The method of claim 1 wherein the probability distribution comprises a maximum entropy probability distribution.

3. The method of claim 1 wherein the probability distribution comprises a relaxation time distribution.

4. The method of claim 1 wherein the probability distribution comprises at least one of an echo amplitude distribution and a window sum distribution.

5. The method of claim 1 wherein the at least one measured response comprises a plurality of measured distribution moments; and wherein determining the probability distribution comprises determining the probability distribution corresponding to the plurality of measured distribution moments.

6. The method of claim 1 wherein the logging device comprises a nuclear magnetic resonance (NMR) logging device, and wherein the at least one measured response comprises at least one NMR echo amplitude.

7. The method of claim 1 wherein determining the plurality of coefficients comprises determining a plurality of quantized values of exponential coefficients representing the probability distribution at the logging tool within the borehole.

8. The method of claim 1 wherein communicating the coefficients comprises communicating the coefficients from the logging tool within the borehole to the receiving device at the surface via telemetry.

9. The method of claim 1 wherein obtaining the at least one measured response comprises obtaining a plurality of measured responses by measuring along a length of the borehole within the geological formation using the logging tool.

10. The method of claim 1 further comprising determining at least one characteristic of the geological formation based upon the received coefficients.

11. The method of claim 10 wherein the at least one characteristic of the geological formation comprises porosity.

12. A logging tool for use with a geological formation having a borehole therein and comprising:
a logging device to obtain at least one measured response for the geological formation from within the borehole; and
a processor cooperating with said logging device to
determine a probability distribution corresponding to the at least one measured response within the borehole,
determine a plurality of coefficients representing the probability distribution within the borehole, and
communicate the coefficients representing the probability distribution from within the borehole to a receiving device at the surface of the borehole and without transmitting the at least one measured response to the receiving device from within the borehole.

13. The logging tool of claim 12 wherein the probability distribution comprises a maximum entropy probability distribution.

14. The logging tool of claim 12 wherein the probability distribution comprises a relaxation time distribution.

15. The logging tool of claim 12 wherein the probability distribution comprises at least one of an echo amplitude distribution and a window sum distribution.

16. The logging tool of claim 12 wherein the at least one measured response comprises a plurality of measured distribution moments; and wherein said processor determines the probability distribution corresponding to the plurality of measured distribution moments.

17. The logging tool of claim 12 wherein the logging device comprises a nuclear magnetic resonance (NMR) logging device, and wherein the at least one measured response comprises at least one NMR echo amplitude.

18. A system for analyzing at least one characteristic of a geological formation having a borehole therein and comprising:
a communications device outside the borehole for communicating with a logging tool within the borehole; and
a processor cooperating with said communications device to
receive a plurality of coefficients from the logging tool representing a probability distribution corresponding to at least one response measured by the logging tool within the borehole, and without receiving the at least one measured response from the logging tool from within the borehole, and
determine at least one characteristic of the geological formation based upon the received plurality of coefficients.

19. The system of claim 18 wherein the probability distribution comprises a maximum entropy probability distribution.

20. The system of claim 18 wherein the probability distribution comprises a relaxation time distribution.

21. The system of claim 18 wherein the probability distribution comprises at least one of an echo amplitude distribution and a window sum distribution.

22. The system of claim 18 wherein the at least one measured response comprises a plurality of measured distribution moments; and wherein the probability distribution corresponds to the plurality of measured distribution moments.

23. The system of claim 16 wherein the logging device comprises a nuclear magnetic resonance (NMR) logging device, and wherein the at least one measured response comprises at least one NMR echo amplitude.

24. A non-transitory computer-readable medium having computer-executable instructions for causing a logging tool within a borehole in a geological formation to at least:
obtain at least one measured response for the geological formation from within the borehole;
determine a probability distribution corresponding to the at least one measured response within the borehole;
determine a plurality of coefficients representing the probability distribution within the borehole; and
communicate the coefficients representing the probability distribution from the logging tool within the borehole to a receiving device at the surface of the borehole and without transmitting the at least one measured response to the receiving device from within the borehole.

25. The non-transitory computer-readable medium of claim 24 wherein the probability distribution comprises a maximum entropy probability distribution.

26. The non-transitory computer-readable medium of claim 24 wherein the probability distribution comprises a relaxation time distribution.

27. The non-transitory computer-readable medium of claim 24 wherein the probability distribution comprises at least one of an echo amplitude distribution and a window sum distribution.

28. The non-transitory computer-readable medium of claim 24 wherein the at least one measured response comprises a plurality of measured distribution moments; and wherein determining the probability distribution comprises determining the probability distribution corresponding to the plurality of measured distribution moments.
